(19) United States
(12) Patent Application Publication
(10) Pub. No.: US 2008/0174250 A1
(43) Pub. Date: Jul. 24, 2008

(54) Oscillated lighting bulb

(76) Inventor: Fong-Shi Lin, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/655,947

(22) Filed: Jan. 22, 2007

(51) Int. Cl. H05B 39/09

(52) U.S. Cl. 315/211

(57) ABSTRACT

The invention relates to an oscillated lighting bulb, which includes a shell, a jointer, and a connector. A controller is provided under the connector, which connects with a central conductive wire and two side tungsten filaments. The conductive wire and the tungsten filaments are parallelly connected and are controlled by the controller, which can lightens the two tungsten filaments alternately. Hence, the bulb obtains an oscillated lighting effect being similar to a real flame.

### BACKGROUND OF THE INVENTION

As shown in FIG. 1, a known bulb includes a shell (1) and a jointer (2). A connector (3) received in the bulb connects with a conductive wire (31) and a tungsten filament (32) to provide a stable lighting effect. The said lighting ray is stable without variety. An improved conventional bulb having a jumping lighting effect is designed as shown in FIG. 2, which includes a lighting body (4) having a flame outlook. The lighting body (4) can be lightened by use of its inner air during heating but it still displays only a poor lighting effect because of being made of metal. Moreover, the lighting body (4) is apt to be broken and is without utilization.

The present invention is to provide an oscillated lighting bulb, which provides a simple structure for producing an oscillated lighting effect being similar to a real flame. Now, accompanying with the following drawings, the character of the present invention will be described here and after.

### BRIEF DESCRIPTION OF THE DRAWINGS

FIG. 1 is a perspective view showing a conventional bulb having a stable lighting effect.

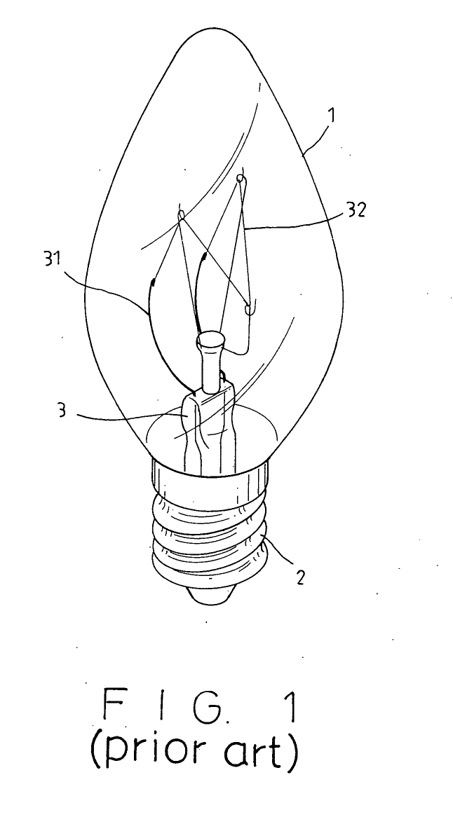

FIG. 2 is a perspective view showing another conventional bulb having a jumping lighting effect.

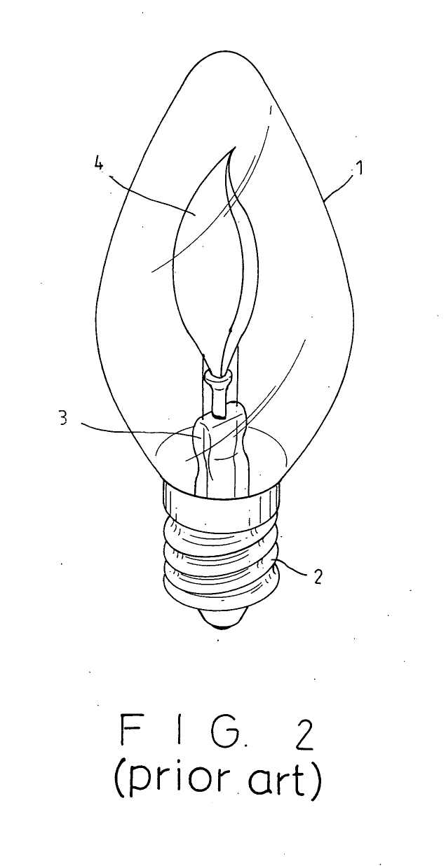

FIG. 3 is a perspective view showing an oscillated lighting bulb according to the present invention.

### DETAILED DESCRIPTION OF THE PREFERRED EMBODIMENT

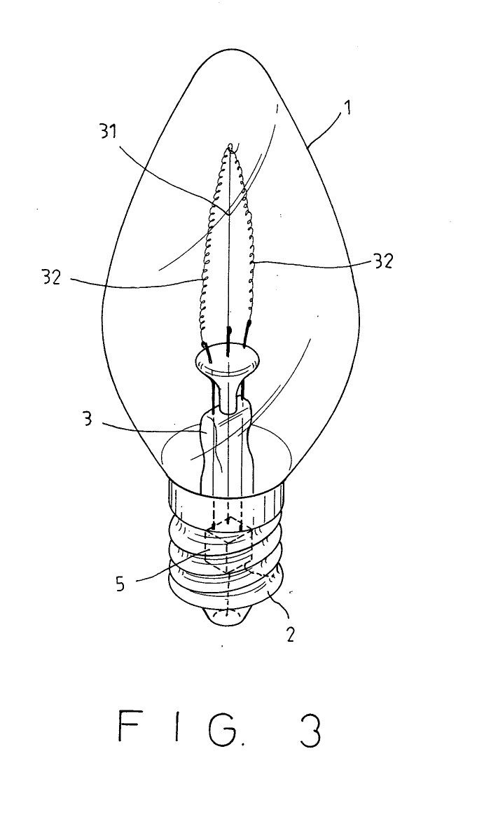

Referring to FIG. 3, the present invention relates to an oscillated lighting bulb, which includes a shell (1) being transparent or semi-transparent, a jointer (2), and a connector (3). A controller (5) is provided under the connector (3), which connects with a central conductive wire (31) and two side tungsten filaments (32). The conductive wire (31) and the tungsten filaments (32) are parallelly connected and are controlled by the controller (5).

In use, the controller (5) controls electrical connection between the conductive wire (31) and one of the tungsten filaments (32) at a single time. And only one tungsten filament (32) can emit lighting ray when it is electrically conducted. Accordingly, the bulb obtains an oscillated lighting effect as the two tungsten filaments (32) are lightened alternately that displays a lighting effect being similar to a real flame having a decorative purpose.

Hence, the present invention uses the controller (5) to control two tungsten filaments (32) being lightened by turn that produces an oscillated lighting effect with decorative outlook. It obtains improvements and utilization and should be allowed for a patent. But about mentioned embodiment is only exemplary and is not to limit the scope of the invention. Any modification with the same merit will be still claimed in the present invention.

I claim:

1. An oscillated lighting bulb including a shell, a jointer, and a connector;
a controller being provided under the connector, which connects with a central conductive wire and two side tungsten filaments, wherein the conductive wire and the tungsten filaments are parallelly connected and are controlled by the controller, which can lightens the two tungsten filaments alternately.
